(19) United States
(12) Patent Application Publication
(10) Pub. No.: US 2006/0187775 A1
(43) Pub. Date: Aug. 24, 2006

(54) Device and method of reducing data-to-pushpull cross-talk

(75) Inventors: Bin Yin, Eindhoven (FR); Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/560,683

(22) PCT Filed: Jun. 3, 2004
(86) PCT No.: PCT/IB04/01913

§ 371 Date: Dec. 14, 2005

(30) Foreign Application Priority Data
Jun. 19, 2003 (EP) 03300034.0

(51) Int. Cl. G11B 7/00

(52) U.S. Cl. 369/44.28

(57) ABSTRACT

The invention relates to a device and method of reducing the cross-talk between a data signal (HF) and an input push-pull signal (PP), for generating an output push-pull signal (IPP), said method comprising: -a convolution step for convoluting said data signal (HF) with a filter (F), for generating a first intermediary signal, -a multiplication step for multiplying said first intermediary signal to an adaptive scaling factor (a), for generating a second intermediary signal, -a subtracting step for subtracting said second intermediary signal to said input push-pull signal (PP), for generating said output push-pull signal (IPP). Use: Optical recording

### FIELD OF THE INVENTION

The invention relates to a device and method of reducing the cross-talk between a data signal and an input push-pull signal, for generating an output push-pull signal.

The invention may be used in the field of optical recording.

### BACKGROUND OF THE INVENTION

For recordable and re-writable optical disc formats, address and other auxiliary format information can be retrieved from the push-pull channel. One way to realize this, for instance, is to master the tracks carrying recorded data with a controlled deviation from their average central positions to form a wobble channel. Being phase modulated (for DVD+R and DVD+RW disc formats), or frequency modulated (4SK for Blue Ray disc format), the wobble channel carries address and other format information. For DVD−R and DVD−RW formats, address information is extracted from land pre-pits (LPP) that are located on top of the wobble signal. To keep a reliable disc access, it is important for optical disc systems to retrieve the address information under all circumstances.

As illustrated in FIG. 1, a push-pull signal PP is derived for example from the difference of the laser light intensity integral between the top half (quadrants Q1 and Q2) and bottom half (quadrants Q3 and Q4) of a four quadrants photo detector PD, on which the light field at the exit pupil of the objective lens is projected. The signal PP is expressed as follows:
PP=(Q1+Q2)−(Q3+Q4) Eq.1
The signal PP may also be normalised as follows:
PP=(Q1+Q2−Q3−Q4)/(Q1+Q2+Q3+Q4) Eq.2

A data signal HF is also derived from the laser light intensity integral of the four quadrants Q1-Q2-Q3-Q4 of the photo detector PD. The data signal HF is expressed as follows:
HF=Q1+Q2+Q3+Q4 Eq.3

Generally, the data information will leak to the push-pull channel if the light diffracted by the data marks does not distribute symmetrically on the two halves of the photo detector. This can be the case in the presence of imperfections in the forward light path, e.g., radial tilt, astigmatism and pupil filling error which yield radially asymmetric laser spot light field, and in the backward light path like beam-landing. This leakage is called the data-to-push-pull cross-talk. Its existence decreases for example the signal-to-noise ratio of the push-pull signal, thus reducing the addressing reliability.

Among various data-to-push-pull cross-talk sources, the forward light path astigmatism, in particular with focal lines 45° with respect to the track direction, is proved to be the dominant one. The cross-talk is stronger as the astigmatism strength increases.

Some optical disc systems use an astigmatic lens placed in the laser light path to generate focusing errors on the photo detector. When the astigmatism of the lens is chosen not sufficiently strong, a similar effect can be observed. In that case, the cross-talk increases as astigmatism strength decreases from the optimal value.

### OBJECT AND SUMMARY OF THE INVENTION

It is an object of the invention to propose a cost-effective signal-processing-based device and method of reducing the cross-talk between a data signal and an input push-pull signal, for generating an improved output push-pull signal.

To this end, the method according to the invention comprises:
a convolution step for convoluting said data signal with a filter, for generating a first intermediary signal,
a multiplication step for multiplying said first intermediary signal to an adaptive scaling factor, for generating a second intermediary signal,
a subtracting step for subtracting said second intermediary signal to said input push-pull signal, for generating said output push-pull signal.

For reducing the cross-talk between a data signal and an input push-pull signal, this method is based on the use of only one adaptable scaling factor. The filter which is used has fixed coefficients which are pre-calculated according to the main causes of the cross-talk, and the number of coefficients may be chosen low. This method is robust since the scaling factor is made adaptive.

Considering the use of a single adaptive factor, and the use of a small kernel of the filter, the hardware complexity is low.

The invention also relates to a device comprising processing means for implementing the steps of the methods according to the invention.

The invention also relates to a computer program comprising code instructions for implementing the steps of the method according to the invention.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts the generation of a data signal and a push-pull signal from a four quadrants photo detector,

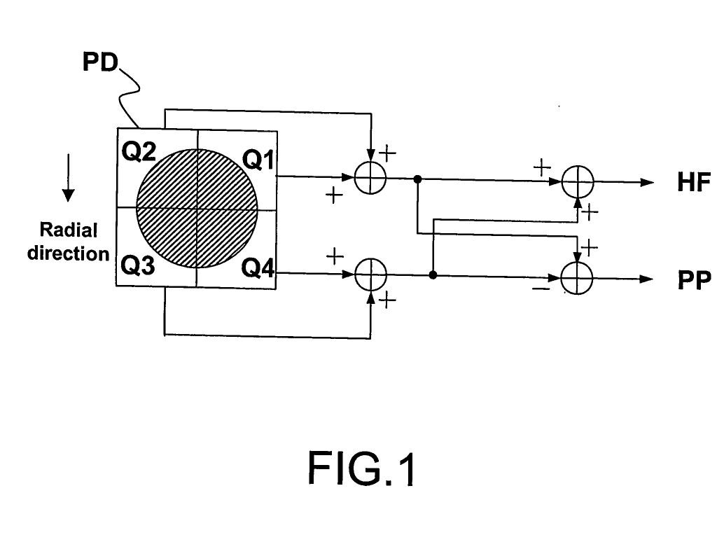

FIG. 2 depicts a first arrangement according to the invention of cross-talk reduction,

FIG. 3 depicts a second arrangement according to the invention of cross-talk reduction.

### DETAILED DESCRIPTION OF THE INVENTION

For generating an improved output push-pull signal IPP, the cross-talk reduction between the data signal HF and the input push-pull signal PP is based on the following equation:
IPP=PP−α F*HF Eq.4
where * denotes the convolution operation.

The filter F is a fixed FIR (Finite Impulse Response) or IIR (Infinite Impulse Response) filter. Its coefficients are pre-calculated according to the main cross-talk causes. For example, it has an anti-symmetric shape in the presence of astigmatism. The data signal HF is convolved with the filter F for generating a first intermediary signal expressed by F*HF. The first intermediary signal is thus multiplied to the adaptive scaling factor α for generating a second intermediary signal expressed by α F*HF. Finally, the second intermediary signal is subtracted to said input push-pull signal PP for generating the output push-pull signal IPP.

The adaptive scaling factor ax may be defined so as to minimize a cost function J indicating the amount of data to push-pull cross-talk. For example, J may correspond to the cross-correlation between the output push-pull signal IPP and the data signal HF as follow:
J(α)={E{IPP×HF}}² Eq.5
where Et{ } stands for the mathematical expectation.
The adaptive factor α can thus be derived recursively from the following equation:

$$\begin{matrix}α ( k + 1 ) = α ( k ) + μ ⨯ {[ - \frac{\partial J ( α )}{\partial α} ]}_{α = α ( k )} & Eq . 6 \\ \frac{\partial J ( α )}{\partial α} {\vert}_{α = α ( k )} \approx - 2 [ {IPP ( H F )}^{2} ( F * H F ) ] ( k ) & Eq . 7\end{matrix}$$

where μ is a factor that controls stability and rate of adaptation,
k is time index of the data sample,
the sign * denotes the convolution operation.

According to the optical disc format which is used, the input push-pull signal PP is not necessarily sampled at the channel bit rate f_{b}, i.e. not necessarily providing one sample per bit mark stored on the optical disc, since the bandwidth of the embedded information in the push-pull channel, for example the wobble signal, may be lower than that of the data signal HF.

Advantageously, for wobble signal detection, the sampling rate can be chosen smaller than the channel bit rate f_{b} as long as the performance of the wobble detection is not degraded. The lower sampling rate for the wobble signal means the less coefficients to describe the filter F. The complexity of the implementation and the power consumption may therefore be significantly decreased.

For instance, in DVD+RW disc format, the input signal PP can be sampled at a frequency f_{c} down to f_{c}=f_{b}/4, i.e. four times lower than the channel bit rate f_{b}. Accordingly, the data signal HF needed in cross-talk cancellation must be sampled at f_{c} as well.

Knowing that the main cause of the data to push-pull channel cross-talk is due to light path astigmatism, the filter F has thus an anti-symmetric shape and its main power concentrates on the central coefficients. Advantageously, the filter F at the sampling rate f_{c}=f_{b}/4 comprises only three coefficients and can be in particular defined by F=[10 −1]. The filter F may be generalized to F=[F_{-N}, . . . , F₀, . . . , F_{N}], which is pre-calculated depending on the sampling frequency f_{c} and the cause of cross-talk, and so not necessarily of the anti-symmetric shape.

For DVD−R and DVD−RW disc formats, f_{c} needs to be higher or advantageously close to the channel bit rate f_{b} since the pre-pit signal is of high frequency, the factor of down sampling being in this last case close to one.

Alternatively, the adaptive scaling factor ax may also be derived from a look-up table establishing a link with signal-to-noise ratio (SNR) values of the signal PP which have been previously calculated from experimentations, in conjunction with the means for determining the sign of α, for example, monitoring online the SNR differentiation of the EPP when a scaling factor α+ε or α−ε is applied, with ε a small variation from α. The sign decision of α is thus done based on the SNR of IPP.

To give an example, for the wobble detection in the DVD+RW format, the signal-to-noise ratio is used and defined in the wobble spectrum as the difference between the signal power at the carrier frequency and at 2˜2.5 times of the carrier frequency in the units of dB.

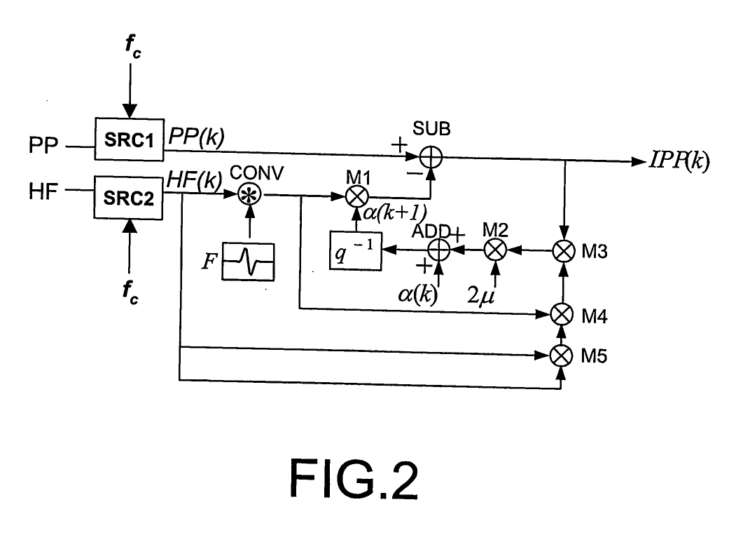

FIG. 2 describes a first arrangement according to the invention implementing the cross-talk reduction as expressed by Eq.4. This arrangement comprises:
a sample rate converters SRC1 for sampling the input push-pull signal PP at a frequency f_{c} advantageously lower than the channel bit rate f_{b},
a sample rate converters SRC2 for sampling the data signal HF at a frequency f_{c} advantageously lower than the channel bit rate f_{b},
convolution means CONV for convoluting the data signal HF with the filter F,
multiplying means M1 for multiplying the signal generated by the convolution means CONV to the adaptive scaling factor α,
subtracting means SUB for subtracting the signal generated by the multiplication means M1 to the input push-pull signal PP, and for generating the output push-pull signal IPP,
addition means ADD, delay means q⁻¹, multiplication means M2-M3-M4-M5 for implementing the recursive calculation of the adaptive scaling factor α.

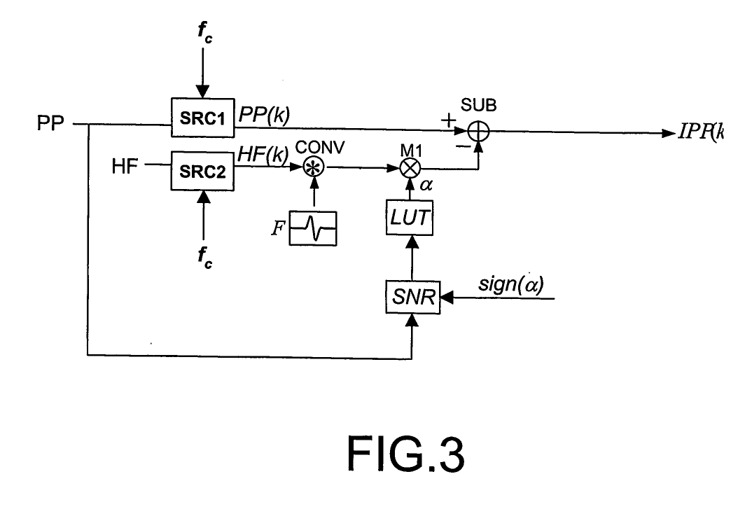

FIG. 3 describes a second arrangement according to the invention implementing the cross-talk reduction as expressed by Eq.4. This arrangement comprises:
a sample rate converters SRC1 for sampling the input push-pull signal PP at a frequency f_{c} advantageously lower than the channel bit rate f_{b},
a sample rate converters SRC2 for sampling the data signal HF at a frequency f_{c} advantageously lower than the channel bit rate f_{b},
convolution means CONV for convoluting the data signal HF with the filter F,
multiplying means M1 for multiplying the signal generated by the convolution means CONV to the adaptive scaling factor α,
subtracting means SUB for subtracting the signal generated by the multiplying means M1 to the input push-pull signal PP, and for generating the output push-pull signal IPP,
calculation means SNR for calculating the signal-to-noise ratio values of the input push-pull signal PP,
a look-up table LUT indexed by signal-to-noise ratio values calculated by the calculation means SNR, for generating the adaptive scaling factor α.

For generating an improved output push-pull signal IPP, the cross-talk reduction between the data signal HF and the input push-pull signal PP may also be based on the following equation:
IPP=PP−F*HF Eq.8
where * denotes the convolution operation.

The adaptive scaling factor a and the fixed filter F of Eq.4 are replaced by an adaptive filter F. The data signal HF is convolved with the filter F for generating an intermediary signal expressed by F*HF. The intermediary signal is thus subtracted to the input push-pull signal PP for generating the output push-pull signal IPP.

The filter F is an FIR filter of which the coefficients are adaptively modified. The coefficients of filter F may be defined so as to minimize the function J expressed for example as the cross-correlation between the output push-pull signal IPP and the data signal HF, as expressed by Eq.5. More generally, the function J can be chosen in any form which indicates the amount of data leakage to the push-pull signal. The coefficients Fᵢ of the filter F can thus be derived recursively from the following equation:

$$\begin{matrix}{F}_{i} ( k + 1 ) = {F}_{i} ( k ) + μ ⨯ {[ - \frac{\partial J ( F )}{\partial {F}_{i}} ]}_{{F}_{i} = {F}_{i} ( k )} & Eq . 9 \\ \frac{\partial J ( F )}{\partial {F}_{i}} {\vert}_{{F}_{i} = {F}_{i} ( k )} \approx - 2 [ {IPP ( H F )}^{2} ] ( k ) H F ( k - i ) & Eq . 10\end{matrix}$$

Similarly, the cross-talk cancelling may work at a rate f_{c} lower than the channel bit rate f_{b}. For instance, for the wobble detection in DVD+RW format, the input signal PP and the data signal HF are advantageously sampled at a frequency f_{c}=f_{b}/4, i.e. four times lower than the channel bit rate f_{b}.

In this case, the filter F may comprise only three coefficients Fᵢ and can be in particular defined by F=[F₋₁ F₀ F₁], with F₋₁=1, F₀=0 and F₁=−1 as initial values assuming the astigmatism is the main cross-talk cause.

The filter F may be also generalized to F=[F_{-N}, . . . , F₀, . . . , F_{N}], with some coefficients probably set non-adaptive. The number of coefficients defining the filter F varies according to the sampling frequency and the cause of cross-talk. In particular, the span N decreases as the sampling frequency f_{c} decreases compared to the channel bit rate f_{b}.

In an optical data carrier reader and/or writer, such a method can be implemented in a device for generating an improved push-pull signal, such as in an electronic module or in an integrated circuit, said device comprising processing means for implementing the various steps of the method according to the invention previously described. In particular, the invention relates to a device for reducing the cross-talk between a data signal (HF) and an input push-pull signal (PP), for generating an output push-pull signal (IPP), said method comprising:
convolution means for convoluting said data signal (HF) with a filter (F), for generating a first intermediary signal,
multiplication means for multiplying said first intermediary signal to an adaptive scaling factor (α), for generating a second intermediary signal,
subtracting means for subtracting said second intermediary signal to said input push-pull signal (PP), for generating said output push-pull signal (IPP).

The convolution, multiplication and subtracting means, are advantageously performed by code instructions (e.g. as a computer program stored in a memory) executed by a signal processor.

The verb “comprise” does not exclude the presence of other elements than those listed in the claims.

1. Method of reducing the cross-talk between a data signal (HF) and an input push-pull signal (PP), for generating an output push-pull signal (IPP), said method comprising:
a convolution step for convoluting said data signal (HF) with a filter (F), for generating a first intermediary signal,
a multiplication step for multiplying said first intermediary signal to an adaptive scaling factor (α), for generating a second intermediary signal,
a subtracting step for subtracting said second intermediary signal to said input push-pull signal (PP), for generating said output push-pull signal (IPP).

2. Method as claimed in claim 1 where said adaptive scaling factor (α) is defined so as to minimize a cost function (J) that indicates the amount of data to push-pull cross-talk.

3. Method as claimed in claim 1 where said adaptive scaling factor (α) is derived from a look-up table (LUT) indexed with signal-to-noise ratio values of the push-pull signal (PP).

4. Method as claimed in claim 2 comprising sampling steps (SRC1, SRC2) for sampling said data signal (HF) and said input push-pull signal (PP) at a frequency (f_{c}) lower than the channel bit rate (f_{b}) of the data signal (HF).

5. Method as claimed in claim 4 where the filter (F) is defined by [1 0 −1].

6. Device for reducing the cross-talk between a data signal (HF) and an input push-pull signal (PP), for generating an output push-pull signal (IPP), said method comprising:
convolution means for convoluting said data signal (HF) with a filter (F), for generating a first intermediary signal,
multiplication means for multiplying said first intermediary signal to an adaptive scaling factor (α), for generating a second intermediary signal,
subtracting means for subtracting said second intermediary signal to said input push-pull signal (PP), for generating said output push-pull signal (IPP).

7. A computer program comprising code instructions for implementing the steps of the method as claimed in claim 1.
